(19) United States
(12) Patent Application Publication
(10) Pub. No.: US 2023/0177792 A1
(43) Pub. Date: Jun. 8, 2023

(54) METHOD OF OPERATING A CAMERA ASSEMBLY IN AN INDOOR GARDENING APPLIANCE

(71) Applicant: Haier US Appliance Solutions, Inc., Wilmington, DE (US)

(72) Inventors: Christopher Hayward Osborne, Louisville, KY (US); John Alexander Gardner, Louisville, KY (US)

(21) Appl. No.: 17/540,812

(22) Filed: Dec. 2, 2021

(51) Int. Cl. G06V 10/12; G06V 10/98; G06V 10/94; A01G 7/04; G06V 10/774; A01G 9/02; G06V 10/82; H04N 7/18

(52) U.S. Cl. CPC G06V 10/12; G06V 10/993; G06V 10/95; A01G 7/045; G06V 10/774; A01G 9/023; G06V 10/82; H04N 7/183

(57) ABSTRACT

A gardening appliance includes a grow tower rotatably mounted within a liner and having a plurality of apertures for receiving one or more plant pods. A controller is operably coupled to a drive motor and a camera assembly and is configured to operate the drive motor to rotate the grow tower while obtaining a series of images. The controller is further configured to analyze the series of images using a machine learning image recognition process to identify a target image of the series of images that corresponds to an image having the best image quality or clarity.

### FIELD OF THE INVENTION

The present subject matter relates generally to systems for gardening plants indoors, and more particularly, to camera assemblies within gardening appliances and methods of operating the same.

### BACKGROUND OF THE INVENTION

Conventional indoor garden centers include a cabinet defining a grow chamber having a number of trays or racks positioned therein to support seedlings or plant material, e.g., for growing herbs, vegetables, or other plants in an indoor environment. In addition, such indoor garden centers may include an environmental control system that maintains the growing chamber at a desired temperature or humidity. Certain indoor garden centers may also include hydration systems for watering the plants and/or artificial lighting systems that provide the light necessary for such plants to grow.

Certain indoor gardening appliances include a grow tower that includes features for supporting a plurality of plants. This grow tower may be a large, rotating structure that is primarily supported from a single motor shaft centered below the tower and driven by a drive motor. Monitoring plant growth within such indoor garden centers can be difficult. For instance, users may travel for a period of time and be unable to directly observe plants within the indoor garden centers.

Accordingly, an improved indoor gardening appliance would be useful. More specifically, an indoor gardening appliance that allows a user to monitor plant growth within the indoor garden center would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a gardening appliance defining a vertical direction is provided. The gardening appliance includes a liner positioned within a cabinet and defining a grow chamber, a grow tower rotatably mounted within the liner, the grow tower defining a root chamber, the grow tower having a plurality of apertures for receiving one or more plant pods, a motor assembly operably coupled to the grow tower for selectively rotating the grow tower, a camera assembly positioned and oriented for capturing one or more images of the grow tower, and a controller in operative communication with the camera assembly. The controller is configured to operate the motor assembly to rotate the grow tower, obtain a series of images as the grow tower is rotated, and analyze the series of images using a machine learning image recognition process to identify a target image of the series of images.

In another exemplary embodiment, a method of operating a camera assembly in a gardening appliance is provided. The gardening appliance includes a grow tower rotatably mounted within a liner and having a plurality of apertures for receiving one or more plant pods, and a motor assembly operably coupled to the grow tower for selectively rotating the grow tower. The method includes operating the motor assembly to rotate the grow tower, obtaining a series of images as the grow tower is rotated, and analyzing the series of images using a machine learning image recognition process to identify a target image of the series of images.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a gardening appliance according to an exemplary embodiment of the present subject matter.

FIG. 2 depicts a front view of the exemplary gardening appliance of FIG. 1 with the doors open according to an exemplary embodiment of the present subject matter.

FIG. 3 is a cross sectional view of the exemplary gardening appliance of FIG. 1, taken along Line 3-3 from FIG. 2.

FIG. 4 is a top perspective view of the exemplary gardening appliance of FIG. 1, with a top panel and doors removed according to an exemplary embodiment of the present subject matter.

FIG. 5 is a perspective cross-sectional view of the exemplary gardening appliance of FIG. 1, taken along Line 5-5 from FIG. 2.

FIG. 6 is a top cross-sectional view of the exemplary gardening appliance of FIG. 1, taken along Line 5-5 from FIG. 2.

FIG. 7 provide a perspective view of a grow tower of the exemplary gardening appliance of FIG. 1 according to an exemplary embodiment of the present subject matter.

FIG. 8 provides a method of operating a camera assembly in a gardening appliance according to an exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Referring now to the figures, a gardening appliance 100 will be described in accordance with exemplary aspects of the present subject matter. According to exemplary embodiments, gardening appliance 100 may be used as an indoor garden center for growing plants. It should be appreciated that the embodiments described herein are intended only for explaining aspects of the present subject matter. Variations and modifications may be made to gardening appliance 100 while remaining within the scope of the present subject matter.

According to exemplary embodiments, gardening appliance 100 includes a cabinet 102 that is generally configured for containing and/or supporting various components of gardening appliance 100 and which may also define one or more internal chambers or compartments of gardening appliance 100. In this regard, as used herein, the terms “cabinet,” “housing,” and the like are generally intended to refer to an outer frame or support structure for gardening appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of gardening appliance 100. By contrast, cabinet 102 may enclose some or all portions of an interior of cabinet 102. It should be appreciated that cabinet 102 may have any suitable size, shape, and configuration while remaining within the scope of the present subject matter.

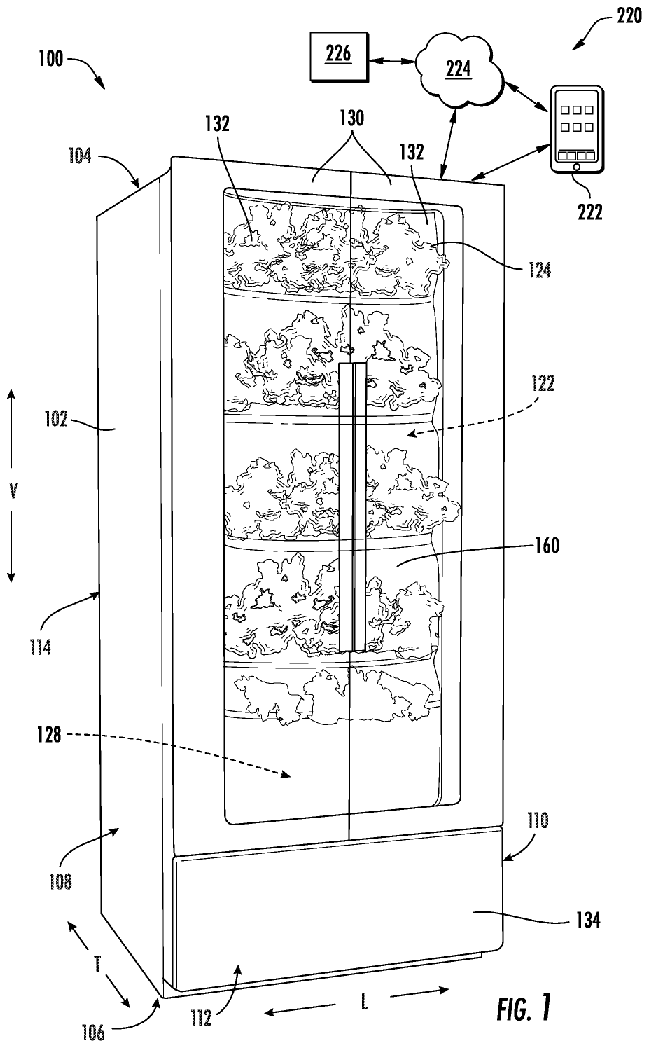

As illustrated, gardening appliance 100 generally defines a vertical direction V, a lateral direction L, and a transverse direction T, each of which is mutually perpendicular, such that an orthogonal coordinate system is generally defined. The horizontal direction is generally intended to refer to a direction perpendicular to the vertical direction V (e.g., within a plane defined by the lateral direction L and the transverse direction T). Cabinet 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing gardening appliance 100.

Gardening appliance 100 may include an insulated liner 120 positioned within cabinet 102. Liner 120 may at least partially define an internal temperature-controlled chamber, referred to herein generally as a climate-controlled chamber 122, within which plants 124 may be grown. Although gardening appliance 100 is referred to herein as growing plants 124, it should be appreciated that other organisms or living things may be grown or stored in gardening appliance 100. For example, algae, fungi (e.g., including mushrooms), or other living organisms may be grown or stored in gardening appliance 100. The specific application described herein is not intended to limit the scope of the present subject matter in any manner.

Cabinet 102, or more specifically, liner 120 may define a substantially enclosed back portion 126 (e.g., proximate rear 114 of cabinet 102). In addition, cabinet 102 and liner 120 may define a front opening, referred to herein as front display opening 128 (e.g., proximate front 112 of cabinet 102), through which a user of gardening appliance 100 may access climate-controlled chamber 122, e.g., for harvesting, planting, pruning, or otherwise interacting with plants 124. According to an exemplary embodiment, enclosed back portion 126 may be defined as a portion of liner 120 that defines climate-controlled chamber 122 proximate rear side 114 of cabinet 102. In addition, front display opening 128 may generally be positioned proximate or coincide with front side 112 of cabinet 102.

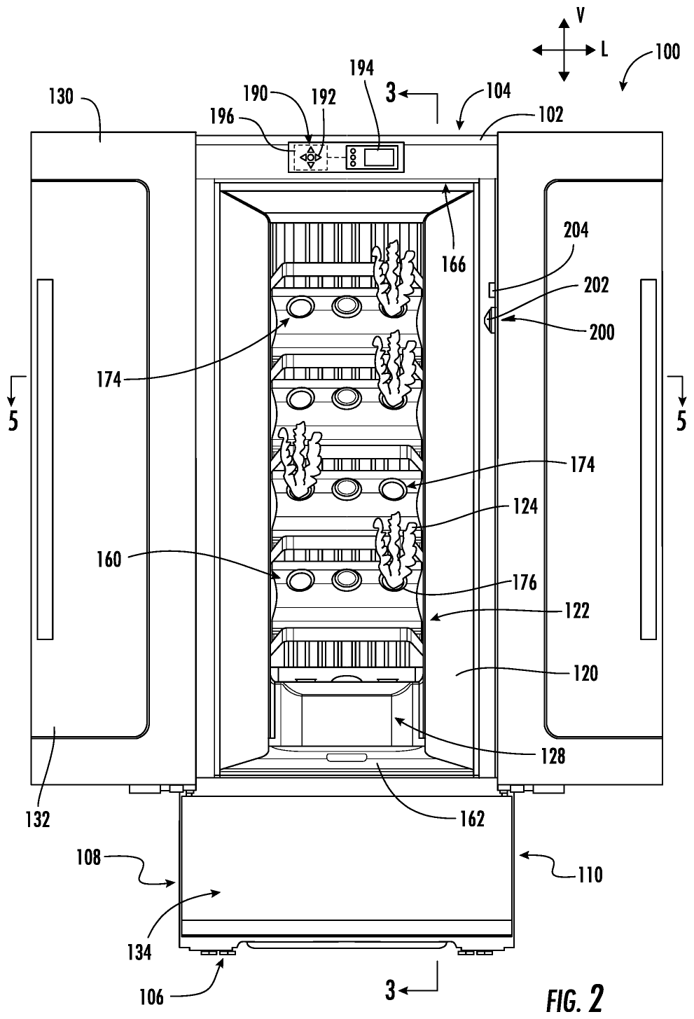

Gardening appliance 100 may further include one or more doors 130 that are rotatably mounted to cabinet 102 for providing selective access to climate-controlled chamber 122. For example, FIG. 1 illustrates doors 130 in the closed position such that they may help insulate climate-controlled chamber 122. By contrast, FIG. 2 illustrates doors 130 in the open positioned to permit access to climate-controlled chamber 122 and plants 124 stored therein. Doors 130 may further include a transparent window 132 through which a user may observe plants 124 without opening doors 130.

Although doors 130 are illustrated as being rectangular and being mounted on front side 112 of cabinet 102 in FIGS. 1 and 2, it should be appreciated that according to alternative embodiments, doors 130 may have different shapes, mounting locations, etc. For example, doors 130 may be curved, may be formed entirely from glass, etc. In addition, doors 130 may have integral features for controlling light passing into and/or out of climate-controlled chamber 122, such as internal louvers, tinting, UV treatments, polarization, etc. One skilled in the art will appreciate that other chamber and door configurations are possible and within the scope of the present subject matter.

According to the illustrated embodiment, cabinet 102 further defines a drawer 134 positioned proximate bottom 106 of cabinet 102 and being slidably mounted to cabinet 102 for providing convenient storage for plant nutrients, system accessories, water filters, etc. In addition, behind drawer 134 is a mechanical compartment 136 for receipt of an environmental control system including a sealed system for regulating the temperature within climate-controlled chamber 122, as described in more detail below.

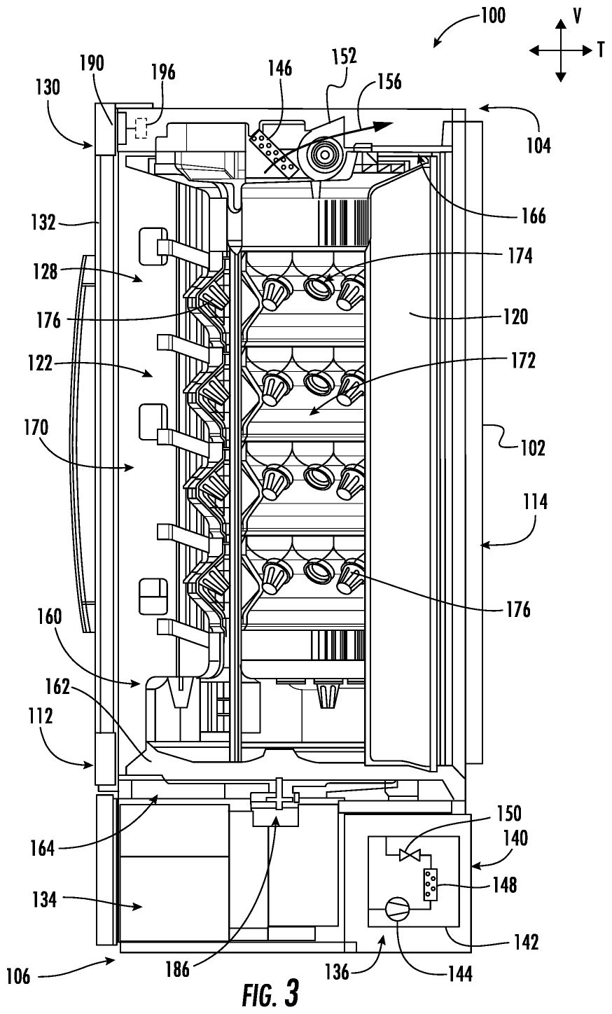

FIG. 3 provides a schematic view of certain components of an environmental control system 140 that may be used to regulate a climate or environment within climate-controlled chamber 122. Specifically, environmental control system 140 may include one or more subsystems for regulating temperature, humidity, hydration, nutrient dosing, lighting, and any other aspects of the environment within one or more portions of climate-controlled chamber 122, e.g., as desired to facilitate improved or regulated growth of plants 124 positioned therein. Although exemplary subsystems and subsystem configurations are described below, it should be appreciated that aspects of environmental control system 140 may vary while remaining within the scope of the present subject matter.

As illustrated, environmental control system 140 includes a sealed system 142 that is generally configured for regulating a temperature and/or humidity within one or more regions of climate-controlled chamber 122. In this regard, as shown schematically in FIG. 3, sealed system 142 may be located partially within mechanical compartment 136 and includes a compressor 144, a first heat exchanger or evaporator 146 and a second heat exchanger or condenser 148. As is generally understood, compressor 144 is generally operable to circulate or urge a flow of refrigerant through sealed system 142, which may include various conduits which may be utilized to flow refrigerant between the various components of sealed system 142. Thus, evaporator 146 and condenser 148 may be between and in fluid communication with each other and compressor 144.

During operation of sealed system 142, refrigerant flows from evaporator 146 and to compressor 144. For example, refrigerant may exit evaporator 146 as a fluid in the form of a superheated vapor. Upon exiting evaporator 146, the refrigerant may enter compressor 144, which is operable to compress the refrigerant and direct the compressed refrigerant to condenser 148. Accordingly, the pressure and temperature of the refrigerant may be increased in compressor 144 such that the refrigerant becomes a more superheated vapor.

Condenser 148 is disposed downstream of compressor 144 and is operable to reject heat from the refrigerant. For example, the superheated vapor from compressor 144 may enter condenser 148 and transfer energy to air surrounding condenser 148 (e.g., to create a flow of heated air). In this manner, the refrigerant condenses into a saturated liquid and/or liquid vapor mixture. A condenser fan (not shown) may be positioned adjacent condenser 148 and may facilitate or urge the flow of heated air across the coils of condenser 148 (e.g., from ambient atmosphere) in order to facilitate heat transfer.

According to the illustrated embodiment, an expansion device or a variable electronic expansion valve 150 may be further provided to regulate refrigerant expansion. During use, variable electronic expansion valve 150 may generally expand the refrigerant, lowering the pressure and temperature thereof. In this regard, refrigerant may exit condenser 148 in the form of high liquid quality/saturated liquid vapor mixture and travel through variable electronic expansion valve 150 before flowing through evaporator 146. Variable electronic expansion valve 150 is generally configured to be adjustable, e.g., such that the flow of refrigerant (e.g., volumetric flow rate in milliliters per second) through variable electronic expansion valve 150 may be selectively varied or adjusted.

Evaporator 146 is disposed downstream of variable electronic expansion valve 150 and is operable to heat refrigerant within evaporator 146, e.g., by absorbing thermal energy from air surrounding the evaporator (e.g., to create a flow of cooled air). For example, the liquid or liquid vapor mixture refrigerant from variable electronic expansion valve 150 may enter evaporator 146. Within evaporator 146, the refrigerant from variable electronic expansion valve 150 receives energy from the flow of cooled air and vaporizes into superheated vapor and/or high-quality vapor mixture. An air handler or evaporator fan 152 is positioned adjacent evaporator 146 and may facilitate or urge the flow of cooled air across evaporator 146 in order to facilitate heat transfer. From evaporator 146, refrigerant may return to compressor 144 and the vapor-compression cycle may continue.

As explained above, environmental control system 140 includes a sealed system 142 for providing a flow of heated air or a flow cooled air throughout climate-controlled chamber 122 as needed. To direct this air, environmental control system 140 may include a duct system 154 for directing the flow of temperature regulated air, identified herein simply as flow of air 156 (see, e.g., FIG. 3). In this regard, for example, evaporator fan 152 can generate a flow of cooled air as the air passes over evaporator 146 and a condenser fan (not shown) can generate a flow of heated air as the air passes over condenser 148.

This temperature-regulated flow of air 156 may be routed through a cooled air supply duct and/or heated air may be routed through a heated air supply duct (not shown). In this regard, it should be appreciated that environmental control system 140 may generally include a plurality of ducts, dampers, diverter assemblies, and/or air handlers to facilitate operation in a cooling mode, in a heating mode, in both a heating and cooling mode, or any other mode suitable for regulating the environment within climate-controlled chamber 122. It should be appreciated that duct system 154 may vary in complexity and may regulate the flows of air from sealed system 142 in any suitable arrangement through any suitable portion of climate-controlled chamber 122.

Although an exemplary sealed system 142 and duct system 154 are illustrated and described herein, it should be appreciated that variations and modifications may be made to sealed system 142 and/or duct system 154 while remaining within the scope of the present subject matter. For example, sealed system 142 may include additional or alternative components, duct system 154 may include additional or different ducting configurations, etc. For example, according to the illustrated embodiment, evaporator 146 and evaporator fan 152 may be positioned at top 104 of cabinet 102 and refrigerant may be routed from mechanical compartment 136 and through cabinet 102 to evaporator 146. In addition, it should be appreciated that gardening appliance 100 may have one or more subsystems integrated with or operably coupled to duct system 154 for filtering the flow of air 156, regulating the concentration of one or more gases within the flow of air 156, etc.

Referring now generally to FIGS. 1 through 7, gardening appliance 100 generally includes a rotatable carousel, referred to herein as a grow tower 160 that is mounted within liner 120, e.g., such that it is within climate-controlled chamber 122. More specifically, grow tower 160 may be positioned on top of a turntable 162 that is rotatably mounted to a sump 164 of gardening appliance 100. In general, grow tower 160 extends along the vertical direction V from sump 164 to a top wall 166 of climate-controlled chamber 122.

In addition, grow tower 160 is generally rotatable about a central axis 168 defined by turntable 162. Specifically, according to the illustrated embodiment, central axis 168 is parallel to the vertical direction V. However, it should be appreciated that central axis 168 could alternatively extend in any suitable direction, e.g., such as the horizontal direction (e.g., defined by the lateral direction L and the transverse direction T). In this regard, grow tower 160 generally defines an axial direction A, i.e., parallel to central axis 168, a radial direction R that extends perpendicular to central axis 168, and a circumferential direction C that extends around central axis 168 (e.g., in a plane perpendicular to central axis 168).

As illustrated, grow tower 160 may generally separate, divide, or partition climate-controlled chamber 122 into a plurality of grow chambers (e.g., identified generally by reference numeral 170). More specifically, grow chambers 170 are generally defined between grow tower 160 and liner 120 or between grow tower 160 and doors 130. In general, grow chambers 170 are intended to support the leafy growth of plants 124 (e.g., or other portions of plants 124 other than the plant roots). According to the illustrated embodiment, grow tower 160 divides climate control chamber 122 into three grow chambers 170, referred to herein generally as a first chamber, a second chamber, and a third chamber. As illustrated, these grow chambers 170 are circumferentially spaced relative to each other and define substantially separate and distinct growing environments. As such, each grow chamber 170 may receive plants 124 having different growth needs and the grow environment within each respective grow chamber 170 may be maintained as grow tower 160 is rotated within climate-controlled chamber 122.

In addition, according to the illustrated embodiment, grow tower 160 may generally define an internal chamber, referred to herein as a root chamber 172. In general, root chamber 172 may be substantially sealed relative to (or isolated from) grow chambers 170 and is configured for containing the roots of plants 124 throughout the growing process. As will be described in more detail below, grow tower 160 may generally define one or more apertures 174 that are defined through grow tower 160 to permit access between grow chambers 170 and root chamber 172. According to exemplary embodiments, these apertures 174 may be configured to receive plant pods 176 into root chamber 172.

Plant pods 176 generally contain seedlings, root balls, or other plant material for growing plants 124 positioned within a mesh or other support structure through which roots of plants 124 may grow within grow tower 160. A user may insert a portion of plant pod 176 (e.g., a seed end or root end) having the desired seeds through one of the plurality of apertures 174 into root chamber 172. A plant end (e.g., opposite the root end) of the plant pod 176 may remain within grow chamber 170 such that plants 124 may grow from grow tower 160 such that they are accessible by a user.

As will be explained below, water and other nutrients may be supplied to the root end of plant pods 176 within root chamber 172. For example, a hydration system may be configured to provide a flow of hydrating mist including water, nutrients, and other suitable constituents for providing the desirable growth environment for plants 124. According to exemplary embodiments, apertures 174 may be covered by a flat flapper seal or seal cap (not shown) to prevent hydrating mist from escaping root chamber 172 when no plant pod 176 is installed and to facilitate improved climate control within root chamber 172 and grow chambers 170. In addition, according to the illustrated embodiment, root chamber 172 may be operably coupled with sealed system 142 for facilitating suitable climate control within the root chamber 172, e.g., to achieve desirable growing conditions.

Although grow tower 160 described and illustrated above includes a single root chamber 172, it should be appreciated that according to alternative exemplary embodiments, grow tower 160 may further include one or more internal dividers (not shown) that are positioned within root chamber 172 to divide root chamber 172 into a plurality of sub-chambers or root chambers. Each of these root chambers may be partially or substantially isolated from the other root chambers to facilitate independent climate control, hydration, gas regulation, etc. In addition, each of these root chambers may be in fluid communication with one of the plurality of grow chambers 170 through the plurality of apertures 174.

Notably, it may be desirable according to exemplary embodiments to form a fluid-tight seal between the grow tower 160 and liner 120. In this manner, as grow tower 160 rotates within climate-controlled chamber 122, grow chambers 170 may remain fluidly isolated from each other. Therefore, according to an exemplary embodiment, grow tower 160 may generally define a grow module diameter (e.g., defined by its substantially circular footprint formed in a horizontal plane). Similarly, enclosed back portion 126 of liner 120 may be substantially cylindrical and may define a liner diameter (not labeled). In order to prevent a significant amount of air from escaping between grow tower 160 and liner 120, and in order to fluidly isolate the various grow chambers 170, the liner diameter may be substantially equal to or slightly larger than the grow module diameter.

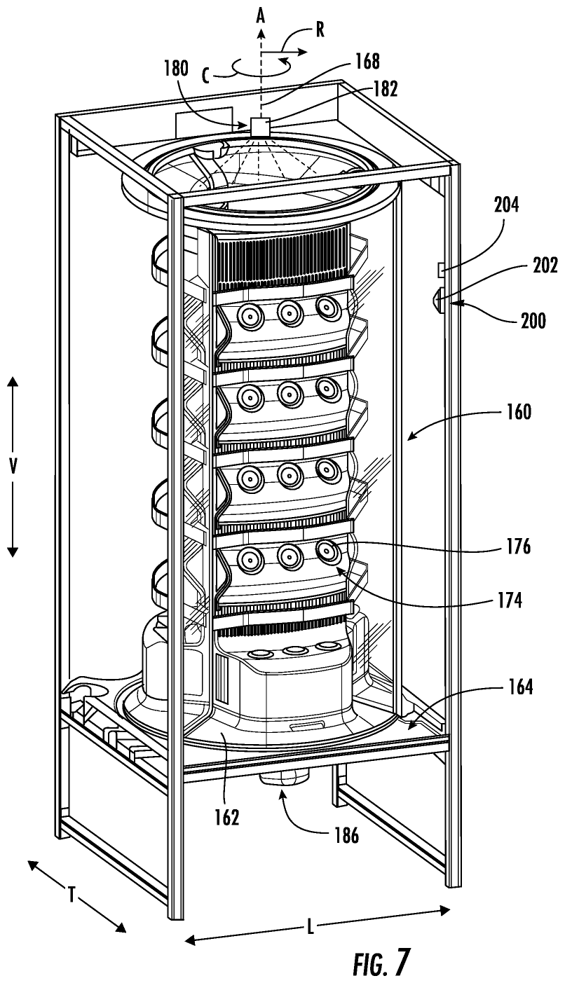

As best shown in FIG. 7, environmental control system 140 may further include a hydration system 180 which is generally configured for providing water and/or nutrients to plants 124 to support their growth. Specifically, according to the illustrated embodiment, hydration system 180 may be fluidly coupled to a water supply and or nutrient distribution assembly to selectively provide desirable quantities and concentrations of hydration, nutrients, and/or other fluids onto plants 124 to facilitate improved plant growth. For example, hydration system 180 includes misting device 182 (e.g., such as a fine mist spray nozzle or nozzles) that is fluidly coupled to a water supply (not shown). For example, the water supply may be a reservoir containing water (e.g., distilled water) or may be a direct connection municipal water supply. According to exemplary embodiments, hydration system 180 may include one or more pumps (not shown) for providing a flow of liquid nutrients to misting device 182. In this regard, for example, water or nutrients that are not absorbed by roots of plants 124 may fall under the force of gravity into sump 164 and these pumps may be fluidly coupled to sump 164 to recirculate the water through misting device 182.

According to the illustrated embodiment, misting device 182 is positioned at a top of root chamber 172 and may be configured for charging root chamber 172 with mist for hydrating the roots of plants 124. Alternatively, misting devices 182 may be positioned at a bottom of root chamber 172 (e.g., within sump 164) for spraying a mist or water into root chamber 172. Because various plants 124 may require different amounts of water for desired growth, hydration system 180 may alternatively include a plurality of misting devices 182, e.g., all coupled to the water supply and/or nutrient supplies. This plurality of misting devices 182 may be spaced apart at along the vertical direction V within root chamber 172. In this manner, these misting devices 182 may provide different concentrations of hydration and/or nutrients to different regions within root chamber 172.

Notably, environmental control system 140 described above is generally configured for regulating the temperature and humidity (e.g., or some other suitable water level quantity or measurement) within one or all of the plurality of chambers 170 and/or root chambers 172 independently of each other. In this manner, a versatile and desirable growing environment may be obtained for each and every chamber 170.

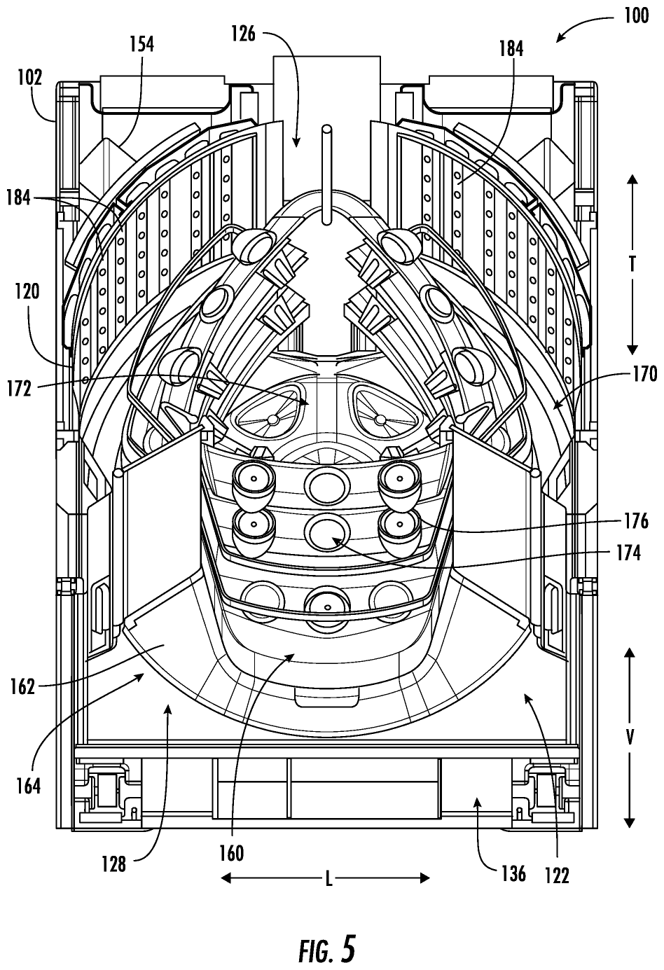

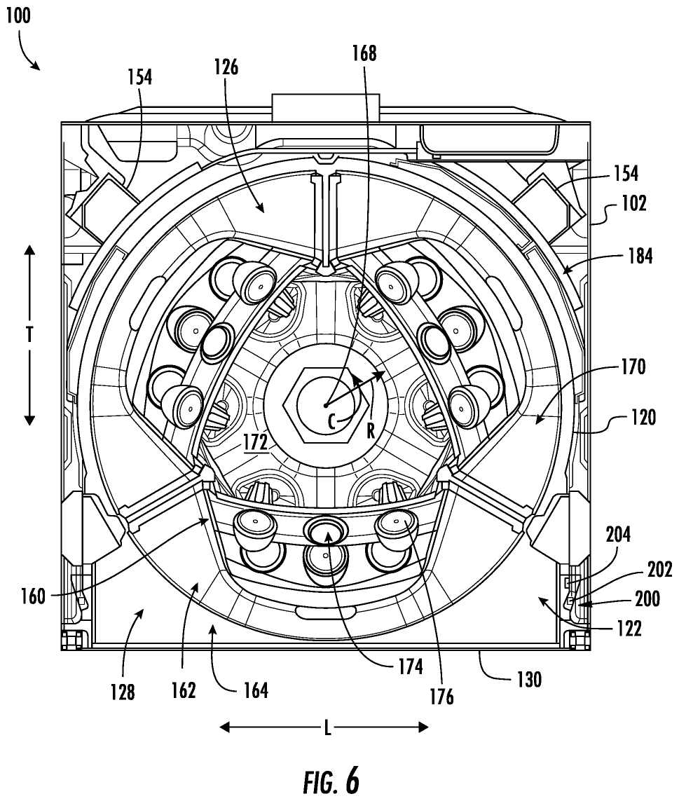

Referring now for example to FIGS. 5 and 6, gardening appliance 100 may further include a light assembly 184 which is generally configured for providing light into selected grow chambers 170 to facilitate photosynthesis and growth of plants 124. As shown, light assembly 184 may include a plurality of light sources (not labeled) stacked in an array, e.g., extending along the vertical direction V. For example, light assembly 184 may be mounted directly to liner 120 within climate-controlled chamber 122 or may alternatively be positioned behind liner 120 such that light is projected through a transparent window or light pipe into climate-controlled chamber 122. The position, configuration, and type of light sources described herein are not intended to limit the scope of the present subject matter in any manner.

Light assembly 184 may include any suitable number, type, position, and configuration of electrical light source(s), using any suitable light technology and illuminating in any suitable color. For example, according to the illustrated embodiment, light assembly 184 includes one or more light emitting diodes (LEDs), which may each illuminate in a single color (e.g., white LEDs), or which may each illuminate in multiple colors (e.g., multi-color or RGB LEDs) depending on the control signal from controller 196. However, it should be appreciated that according to alternative embodiments, light assembly 184 may include any other suitable traditional light bulbs or sources, such as halogen bulbs, fluorescent bulbs, incandescent bulbs, glow bars, a fiber light source, etc.

As explained above, light generated from light assembly 184 may result in light pollution within a room where gardening appliance 100 is located. Therefore, aspects of the present subject matter are directed to features for reducing light pollution, or to the blocking of light from light assembly 184 through front display opening 128. Specifically, as illustrated, light assembly 184 is positioned only within the enclosed back portion 126 of liner 120 such that only grow chambers 170 which are in a sealed position are exposed to light from light assembly 184. Specifically, grow tower 160 acts as a physical partition between light assemblies 184 and front display opening 128. In this manner, as illustrated in FIG. 5, no light may pass from the first or second grow chambers 170 (i.e., the “rear” or enclosed grow chambers 170) through grow tower 160 and out through front display opening 128. As grow tower 160 rotates, two of the three grow chambers 170 will receive light from light assembly 184 at a time. According to still other embodiments, a single light assembly may be used to reduce costs, whereby only a single grow chamber 170 will be illuminated at a single time.

Referring now specifically to FIGS. 3 and 7, gardening appliance 100 may further include a motor assembly 186 or another suitable driving element or device for selectively rotating grow tower 160 during operation of gardening appliance 100. In this regard, according to the illustrated embodiment, motor assembly 186 is positioned below grow tower 160, e.g., within mechanical compartment 136, and may be mechanically coupled to turntable 162 for selectively rotating turntable 162 and grow tower 160 about central axis 168.

As used herein, “motor” may refer to any suitable drive motor and/or transmission assembly for rotating turntable 162 and grow tower 160. For example, motor assembly 186 may include a brushless DC electric motor, a stepper motor, or any other suitable type or configuration of motor. For example, motor assembly 186 may include an AC motor, an induction motor, a permanent magnet synchronous motor, or any other suitable type of AC motor. In addition, motor assembly 186 may include any suitable transmission assemblies, clutch mechanisms, or other components.

Referring again to FIG. 2, gardening appliance 100 may include a control panel 190 that may represent a general-purpose Input/Output (“GPIO”) device or functional block for gardening appliance 100. In some embodiments, control panel 190 may include or be in operative communication with one or more user input devices 192, such as one or more of a variety of digital, analog, electrical, mechanical, or electro-mechanical input devices including rotary dials, control knobs, push buttons, toggle switches, selector switches, and touch pads.

Additionally, gardening appliance 100 may include a display 194, such as a digital or analog display device generally configured to provide visual feedback regarding the operation of gardening appliance 100. For example, display 194 may be provided on control panel 190 and may include one or more status lights, screens, or visible indicators. According to exemplary embodiments, user input devices 192 and display 194 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

Gardening appliance 100 may further include or be in operative communication with a processing device or a controller 196 that may be generally configured to facilitate appliance operation. In this regard, control panel 190, user input devices 192, and display 194 may be in communication with controller 196 such that controller 196 may receive control inputs from user input devices 192, may display information using display 194, and may otherwise regulate operation of gardening appliance 100. For example, signals generated by controller 196 may operate gardening appliance 100, including any or all system components, subsystems, or interconnected devices, in response to the position of user input devices 192 and other control commands. Control panel 190 and other components of gardening appliance 100 may be in communication with controller 196 via, for example, one or more signal lines or shared communication busses. In this manner, Input/Output (“I/O”) signals may be routed between controller 196 and various operational components of gardening appliance 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 196 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 196 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 196 may be operable to execute programming instructions or micro-control code associated with an operating cycle of gardening appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 196 as disclosed herein is capable of and may be operable to perform any methods, method steps, or portions of methods as disclosed herein. For example, in some embodiments, methods disclosed herein may be embodied in programming instructions stored in the memory and executed by controller 196.

The memory devices may also store data that can be retrieved, manipulated, created, or stored by the one or more processors or portions of controller 196. The data can include, for instance, data to facilitate performance of methods described herein. The data can be stored locally (e.g., on controller 196) in one or more databases and/or may be split up so that the data is stored in multiple locations. In addition, or alternatively, the one or more database(s) can be connected to controller 196 through any suitable network(s), such as through a high bandwidth local area network (LAN) or wide area network (WAN). In this regard, for example, controller 196 may further include a communication module or interface that may be used to communicate with one or more other component(s) of gardening appliance 100, controller 196, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

According to an exemplary embodiment, motor assembly 186 may be operably coupled to controller 196, which is programmed to rotate grow tower 160 according to predetermined operating cycles, based on user inputs (e.g., via touch buttons 192), etc. In addition, controller 196 may be communicatively coupled to one or more sensors, such as temperature or humidity sensors, positioned within the various chambers 170 for measuring temperatures and/or humidity, respectively. Controller 196 may then operate motor assembly 186 in order to maintain desired environmental conditions for each of the respective chambers 170. For example, as described herein, gardening appliance 100 includes features or subsystems for providing certain locations of gardening appliance 100 with light, temperature control, proper moisture, nutrients, and other requirements for suitable plant growth. Motor assembly 186 may be used to position specific chambers 170 where needed to receive such growth requirements.

According to an exemplary embodiment, such as where grow tower 160 divides climate-controlled chamber 122 into three grow chambers 170, controller 196 may operate motor assembly 186 to index grow tower 160 sequentially through a number of preselected positions. More specifically, motor assembly 186 may rotate grow tower 160 in a counterclockwise direction (e.g., when viewed from a top of grow tower 160) in 120° increments to move chambers 170 between sealed positions and display positions. As used herein, a chamber 170 is considered to be in a “sealed position” when that chamber 170 is substantially sealed between grow tower 160 and liner 120. By contrast, a chamber 170 is considered to be in a “display position” when that chamber 170 is at least partially exposed to front display opening 128, such that a user may access plants 124 positioned within that chamber 170.

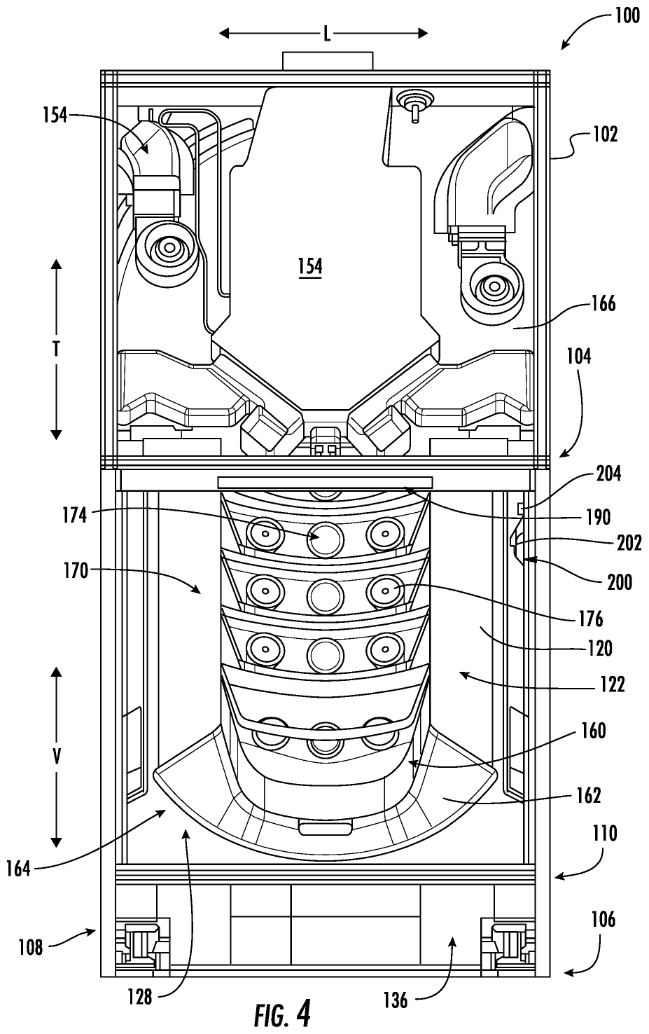

For example, as illustrated in FIGS. 4 and 5, the first grow chamber and the second grow chamber (i.e., the rear chambers) are both in a sealed position, whereas the third grow chamber (i.e., the front chamber) is in a display position. As motor assembly 186 rotates grow tower 160 by 120 degrees in the counterclockwise direction, the second grow chamber will enter the display position, while the first grow chamber and the third grow chamber will be in the sealed positions. Motor assembly 186 may continue to rotate grow tower 160 in such increments to cycle grow chambers 170 between these sealed and display positions.

Gardening appliance 100 and grow tower 160 have been described above to explain an exemplary embodiment of the present subject matter. However, it should be appreciated that variations and modifications may be made while remaining within the scope of the present subject matter. For example, according to alternative embodiments, gardening appliance 100 may be a simplified to a two-chamber embodiment with a square liner 120 and a grow tower 160 that divides the climate-controlled chamber 122 in half to define a first grow chamber and a second grow chamber. According to such an embodiment, by rotating grow tower 160 by 180 degrees about central axis 168, the first chamber may alternate between the sealed position (e.g., facing rear side 114 of cabinet 102) and the display position (e.g., facing front side 112 of cabinet 102). By contrast, the same rotation will move the second chamber from the display position to the sealed position.

According to still other embodiments, gardening appliance 100 may include a three chamber grow tower 160 but may have a modified cabinet 102 such that front display opening 128 is wider and two of the three grow chambers 170 are displayed at a single time. Thus, the first grow chamber may be in the sealed position, while the second grow chamber and the third grow chamber may be in the display positions. As grow tower 160 is rotated counterclockwise, the first grow chamber is moved into the display position and the third grow chamber is moved into the sealed position.

As discussed in greater detail below, a user of gardening appliance 100 may desire to monitor or observe plants within grow chamber 170, e.g., remotely. Thus, gardening appliance 100 includes features for capturing image(s) of grow chamber 170. In particular, referring again briefly to FIGS. 2, 4, 6, and 7, gardening appliance 100 includes a camera assembly 200 that is mounted to cabinet 102 that is configured for capturing image(s) of grow chamber 170. Moreover, as grow tower 160 rotates within cabinet 102, camera assembly 200 may capture image(s) of each grow chamber 170, subsections of grow chamber 170, or portions of grow tower 160.

Specifically, as illustrated in the figures, camera assembly 200 may include a single camera 202 for capturing images of grow chamber 170. Moreover, the single camera 202 may be positioned and oriented for capturing image(s) of the entire height of each portion of grow chamber 170 and/or each section of grow tower 160. For example, single camera 202 may be positioned and oriented for capturing an image of the entire height and/or width of grow section each grow chamber 170 when in the display position. For example, single camera 202 may be mounted in a front corner of cabinet 102, such that single camera 202 has a field of view that can encompass some or all of grow chamber 170 without obstructing view into grow chamber 170 by a user of gardening appliance 100. By using a single camera rather than multiple cameras, costly components may be omitted from gardening appliance 100. Moreover, complex image processing may be avoided.

However, grow tower 160 is tall and thus elongated along the vertical direction V, and the single camera 202 may be positioned in close proximity to grow tower 160 within cabinet 102, e.g., no more than thirty centimeters (30 cm), no more than twenty-five centimeters (25 cm), no more than twenty centimeters (20 cm), etc. from grow tower 160. Thus, capturing image(s) of plants 124 within all apertures 174 in each of first, second, and third chambers grow chambers 170 can be difficult. The single camera 202 may also include a wide-angle curvilinear lens. The position, orientation, and/or lens selection of the single camera 202 can facilitate capturing image(s) of the entire height and/or width (e.g., along the radial direction R) of each grow section of grow chambers 170 with the single camera 202.

As a particular example, the single camera 202 may be positioned on cabinet 102 within a top half of climate-controlled chamber 122. Moreover, the single camera 202 may be positioned on cabinet 102 within a top third of grow chamber 170. Accordingly, the single camera may be positioned above a middle of grow chamber 170, e.g., along the vertical direction V. The single camera 202 may also be positioned at or proximate front display opening 128 and/or the display position for grow tower 160. The single camera 202 may also be oriented such that an optical axis of the single camera 202 defines an angle with the vertical direction V, the angle being no less than five degrees (5°) and no greater than twenty degrees (20°), or about ten degrees (10°). The single camera 202 may be further oriented such that the optical axis of the single camera 202 defines an angle with the lateral direction L, the angle being no less than thirty degrees (30°) and no greater than sixty degrees (60°), or about forty-five degrees (10°). Such positioning and/or orientation of the single camera 202 may advantageously allow the single camera 202 to capture image(s) of the entire height and/or width of each grow section of grow chamber 170.

Controller 196 may be in operative communication with single camera 202. Moreover, controller 196 may be configured for triggering single camera 202 in response to grow tower 160 rotating a threshold angle from a home position of grow tower 160. For instance, when grow tower 160 is positioned such that third chamber 216 is in the display position, controller 196 may activate motor 230 and then trigger single camera 202 to capture an image after grow tower 160 rotates about twenty degrees (20°) from the display position for third chamber 216 Such delayed triggering may facilitate taking images of the grow sections of chambers 212-216 when such portions of grow tower 160 are positioned about normal to optical axis of the single camera 202, e.g., in plane that is perpendicular to the vertical direction V.

Gardening appliance 100 may also include a light assembly 204 positioned at grow chamber 170. Light assembly 204 may be operable to illuminate at least a portion of grow chamber 170. For instance, light assembly 204 may be positioned at or proximate front display opening 128 and/or the display position for grow tower 160. Light assembly 204 may be user operable to illuminate the front display opening 128 and/or the display position for grow tower 160. For example, controller 196 may activate light assembly 204 in response to the user of gardening appliance 100 actuating a light input of input selectors 192 on control panel 190. In addition, controller 196 may activate light assembly 204 when the single camera 202 captures an image. Thus, light assembly 204 may illuminate the field of view of the single camera 202 and/or act as a flash for the single camera 202. Light assembly 204 may include light emitters adjacent camera 202, on both sides of front display opening 128, and/or the display position for grow tower 160, e.g., along the lateral direction L, at a top of front display opening 128 and/or the display position for grow tower 160, etc.

Although the exemplary embodiment of camera assembly 200 described herein and illustrated in the figures includes a single camera 202, it should be appreciated that according to alternative embodiments, camera assembly 200 could include more than one camera. Indeed, aspects of the present subject matter may be used with any suitable number, positioning, and configuration of cameras or other imaging devices.

Referring again to FIG. 1, a schematic diagram of an external communication system 220 will be described according to an exemplary embodiment of the present subject matter. In general, external communication system 220 is configured for permitting interaction, data transfer, and other communications between gardening appliance 100 and one or more external devices. For example, this communication may be used to provide and receive operating parameters, user instructions or notifications, performance characteristics, user preferences, or any other suitable information for improved performance of gardening appliance 100. In addition, it should be appreciated that external communication system 220 may be used to transfer data or other information to improve performance of one or more external devices or appliances and/or improve user interaction with such devices.

For example, external communication system 220 permits controller 196 of gardening appliance 100 to communicate with a separate device external to gardening appliance 100, referred to generally herein as an external device 222. As described in more detail below, these communications may be facilitated using a wired or wireless connection, such as via a network 224. In general, external device 222 may be any suitable device separate from gardening appliance 100 that is configured to provide and/or receive communications, information, data, or commands from a user. In this regard, external device 222 may be, for example, a personal phone, a smartphone, a tablet, a laptop or personal computer, a wearable device, a smart home system, or another mobile or remote device.

In addition, a remote server 226 may be in communication with gardening appliance 100 and/or external device 222 through network 224. In this regard, for example, remote server 226 may be a cloud-based server 226, and is thus located at a distant location, such as in a separate state, country, etc. According to an exemplary embodiment, external device 222 may communicate with a remote server 226 over network 224, such as the Internet, to transmit/receive data or information, provide user inputs, receive user notifications or instructions, interact with or control gardening appliance 100, etc. In addition, external device 222 and remote server 226 may communicate with gardening appliance 100 to communicate similar information.

In general, communication between gardening appliance 100, external device 222, remote server 226, and/or other user devices or appliances may be carried using any type of wired or wireless connection and using any suitable type of communication network, non-limiting examples of which are provided below. For example, external device 222 may be in direct or indirect communication with gardening appliance 100 through any suitable wired or wireless communication connections or interfaces, such as network 224. For example, network 224 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 220 is described herein according to an exemplary embodiment of the present subject matter. However, it should be appreciated that the exemplary functions and configurations of external communication system 220 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Now that the construction of gardening appliance 100 and the configuration of camera assembly 200 according to exemplary embodiments have been presented, an exemplary method 300 of operating a gardening appliance will be described. Although the discussion below refers to the exemplary method 300 of operating gardening appliance 100, one skilled in the art will appreciate that the exemplary method 300 is applicable to the operation of a variety of other gardening appliances. In exemplary embodiments, the various method steps as disclosed herein may be performed by controller 196 or a separate, dedicated controller.

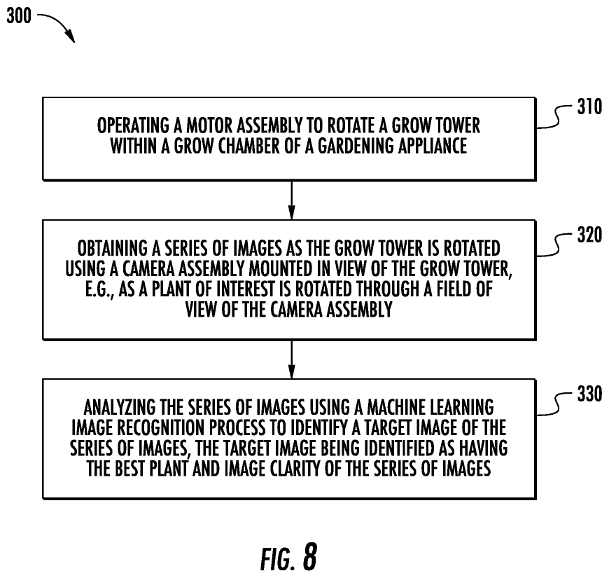

Referring now to FIG. 8, method 300 includes, at step 310, operating a motor assembly to rotate a grow tower within a grow chamber of a gardening appliance. In this regard, continuing the example from above, motor assembly 186 is operably coupled to grow tower 160 for selectively rotating grow tower 160 during normal growth operation or during an imaging process. Notably, as explained briefly above, it may be desirable to periodically obtain images within grow chamber 170, e.g., to monitor the growth of plants 124 or to otherwise assess a condition of grow tower 160 or other components of gardening appliance 100. Accordingly, gardening appliance 100 may include camera assembly 200 for obtaining such images and providing them to the user for informational or diagnostic purposes.

However, the use of multiple cameras may result in an increased number of components, more complex wiring and assembly, and a more expensive appliance. In addition, these additional components and wiring harnesses provide additional failure points which may increase maintenance costs. Moreover, the use of multiple cameras may result in a very large amount of image data, particularly when these cameras obtain images at different points in time and when these images need to be analyzed. Accordingly, aspects of the present subject matter are directed to the use of a single camera 202 to monitor one or more aspects within gardening appliance 100, such as the growth condition of one or more plants 124. Steps 320 and 330 are generally that directed to an efficient manner of obtaining images using camera 202 and selecting the best image for display to the user, such that the remaining may be discarded to reduce data storage, competition analysis, etc.

Specifically, step 320 may generally include obtaining a series of images as the grow tower is rotated using a camera assembly mounted in view of the grow tower, e.g., such as camera assembly 200. In general, the series of images may be obtained such that they include a target of interest, e.g., such as a plant of interest. The series of images may be taken at any suitable frequency and may monitor the point of interest as it is rotated through any suitable angular position to obtain various viewpoints and positions of the plant of interest. Although aspects of the present subject matter are described below as monitoring a plant of interest, it should be appreciated that method 300 may be used to monitor and provide useful information of any other suitable plant or object within gardening appliance 100.

According to exemplary embodiments, in order to determine when to begin obtaining the series of images, method 300 may further include determining a target tower position. For example, the target tower position may be an angular position of grow tower 160 that falls within an arc of rotation through which the series of images are obtained. Thus, for example, the series of images include various frames obtained as the grow tower is rotated past the target tower position. According to exemplary embodiments, determining the target tower position may include identifying a plant of interest and determining the target angular position for that plant of interest. For example, if the plant of interest is selected by a user as being within a center of a first section of grow tower 160, the target angular position may be the angular position of grow tower 160 such that camera 202 has a direct line of focus on the plant of interest, e.g., such that it is substantially normal to grow tower 160.

The series of images may be obtained as the grow tower 160 is rotated through an arc of rotation having any suitable magnitude. For example, the arc of rotation may be selected such that the series of images are obtained while the plant of interest travels through a field of view of camera assembly 200. In this regard, the first image of the series of images may be obtained when the plant of interest is first visible and the last image of the series of images may be obtained as the plant leaves the view of camera 202. According to exemplary embodiments, the arc of rotation may be between about 0° and 120°, between about 5° and 60°, between about 10° and 45°, between about 15° and 30°, or about 20°. Accordingly, for example, if the target angular position of the plant of interest is set at 40° and the arc of rotation is 20°, then the first image of the series of images may be obtained when grow tower 160 is at 30° and the last image of the series of images may be obtained when grow tower 160 is at 50°. It should be appreciated that the target angular position and the arc of rotation may vary while remaining within scope the present subject matter.

According to exemplary embodiments, gardening appliance 100 may be further configured to adjust at least one operating parameter of gardening appliance 100 while obtaining the series of images in order to obtain an improved set of images. In this regard, the terms “operating parameter” and the like may refer to any adjustment that may be made by gardening appliance 100 to affect the images obtained by camera assembly 200. For example, controller 196 may be configured for adjusting light assembly 184 to better illuminate the plant of interest or to otherwise provide different types or intensities of light for improved imaging. According to exemplary embodiments, adjusting the operating parameter may include slowing down the rotation of grow tower 160 as it is rotated past the target angular position. Other operating parameter adjustments are possible and within the scope of the present subject matter.

Notably, of the series of images obtained at step 320, fewer than all of those images may be necessary to provide user or the controller with the desired information. Accordingly, in order to reduce data storage and resources associated with computational analysis of these images, method 300 may include reducing the series of images to one or more target images. Specifically, the example described herein is directed to determining a single target image of the series of images. However, it should be appreciated that according to alternative embodiments, some other subset of the series of images may be selected.

Specifically, step 330 includes analyzing the series of images using a machine learning image recognition process to identify a target image of the series of images. In general, the target image may be the image that provides the most useful information to the user, to the controller, or to any other entity. For example, according to exemplary embodiments, the target image is generally the image selected from the series of images that has the best view or representation of the plant of interest, the best image clarity, etc.

According to exemplary embodiments of the present subject matter, step 330 of analyzing the one or more images may include analyzing the image(s) using a neural network classification module and/or a machine learning image recognition process. In this regard, for example, controller 196 may be programmed to implement the machine learning image recognition process that includes a neural network trained with a plurality of images of plants and/or gardening appliance 100 in different states, containing particular items, at various periods of growth, etc. By analyzing the image(s) obtained at step 320 using this machine learning image recognition process, controller 196 may determine or identify the target image, e.g., by identifying the trained image that is closest to the obtained image. Although the analysis described herein is being performed by controller 196, it should be appreciated that according to alternative embodiments, this analysis may be offloaded to a remote server, such as remote server 226 via network 224.

In general, any suitable number, type, and source of images may be used to train the machine learning image recognition model that is employed at step 330 during the analysis of the series of images. For example, according to exemplary embodiments, the machine learning image recognition model is trained using a plurality of images that include plants being grown in different environments, at different stages of growth, and having different image clarities or qualities. In addition, the plurality of training images may include images that include obstructions that are common within gardening appliance, such as other plants, portions of grow tower 160, fogging conditions associated with the lens of camera 202, etc. In addition, the plurality of training images may include a variety of camera angles, including angles that are classified as poor, angles that are classified as good, etc.

As used herein, the terms image recognition process and similar terms may be used generally to refer to any suitable method of observation, analysis, image decomposition, feature extraction, image classification, etc. of one or more images or videos taken within a gardening appliance. In this regard, the image recognition process may use any suitable artificial intelligence (AI) technique, for example, any suitable machine learning technique, or for example, any suitable deep learning technique. It should be appreciated that any suitable image recognition software or process may be used to analyze images taken by camera assembly 200 and controller 196 may be programmed to perform such processes and identify target images.

According to an exemplary embodiment, controller may implement a form of image recognition called region based convolutional neural network (“R-CNN”) image recognition. Generally speaking, R-CNN may include taking an input image and extracting region proposals that include a potential object, such as a particular region containing a plant of interest and/or an undesirable object within the grow chamber. In this regard, a “region proposal” may be regions in an image that could belong to a particular object, such as the plant of interest or an obstruction within grow chamber. A convolutional neural network is then used to compute features from the regions proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like.

According to still other embodiments, the image recognition process may use any other suitable neural network process. For example, step 330 may include using Mask R-CNN instead of a regular R-CNN architecture. In this regard, Mask R-CNN is based on Fast R-CNN which is slightly different than R-CNN. For example, R-CNN first applies CNN and then allocates it to zone recommendations on the covn5 property map instead of the initially split into zone recommendations. In addition, according to exemplary embodiments standard CNN may be used to analyze the image and determine conditions within the grow chamber. In addition, a K-means algorithm may be used. Other image recognition processes are possible and within the scope of the present subject matter.

According to exemplary embodiments the image recognition process may further include the implementation of Vision Transformer (ViT) techniques or models. In this regard, ViT is generally intended to refer to the use of a vision model based on the Transformer architecture originally designed and commonly used for natural language processing or other text-based tasks. For example, ViT represents an input image as a sequence of image patches and directly predicts class labels for the image. This process may be similar to the sequence of word embeddings used when applying the Transformer architecture to text. The ViT model and other image recognition models described herein may be trained using any suitable source of image data in any suitable quantity. Notably, ViT techniques have been demonstrated to outperform many state-of-the-art neural network or artificial intelligence image recognition processes.

It should be appreciated that any other suitable image recognition process may be used while remaining within the scope of the present subject matter. For example, step 330 may include using a deep belief network (“DBN”) image recognition process. A DBN image recognition process may generally include stacking many individual unsupervised networks that use each network's hidden layer as the input for the next layer. According to still other embodiments, step 330 may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence (“AI”) analysis techniques, and combinations of the above described or other known methods may be used while remaining within the scope of the present subject matter.

FIG. 8 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 300 are explained using gardening appliance 100 as an example, it should be appreciated that this method may be applied to operate a camera assembly in any other suitable gardening appliance.

As explained above, aspects of the present subject matter focus on a camera feature in an indoor plant growing appliance to capture images and select an optimum photo using an artificial intelligence or machine learning algorithm. In specific, an indoor plant growing appliance with a central rotating growing tower includes a camera positioned on the case side at an optimal angle and distance from the tower. The ultra-wide-angle curvilinear lens camera may be capable of taking a complete image of the entire grow tower present in the display chamber at a given time. Images of each tower side may be captured and stored on the unit, cloud, or software application.

According to an exemplary embodiment, the camera may be set to begin capturing images prior to a target tower position. Several images or frames may be captured as the tower rotates past the camera. Artificial intelligence or machine learning algorithms may create a training image library to represent the ideal image to be selected from the plurality of images of rotating tower captured by the camera. The library can consider aspects such as the best angle of the tower, plants that may obstruct the image, or the best lighting to analyze each image. These algorithms can be located in a cloud environment, and multiple image streams may be sent directly from the device to the cloud for post-processing in the cloud and the output from the algorithm may be the best image from the set that was identified.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A gardening appliance defining a vertical direction, the gardening appliance, comprising:
a liner positioned within a cabinet and defining a grow chamber;
a grow tower rotatably mounted within the liner, the grow tower defining a root chamber, the grow tower having a plurality of apertures for receiving one or more plant pods;
a motor assembly operably coupled to the grow tower for selectively rotating the grow tower;
a camera assembly positioned and oriented for capturing one or more images of the grow tower; and
a controller in operative communication with the camera assembly, the controller being configured to:
operate the motor assembly to rotate the grow tower;
identify a plant of interest;
determine a target tower position based on the plant of interest;
obtain a series of images as the grow tower is rotated past the target tower position; and
analyze the series of images using a machine learning image recognition process to identify a target image of the series of images, wherein the target image is identified as having the best view or representation of the plant of interest from the series of images.

2. (canceled)

3. (canceled)

4. The gardening appliance of claim 1, wherein the series of images are obtained while the plant of interest travels through a field of view of the camera assembly.

5. (canceled)

6. The gardening appliance of claim 1, wherein the machine learning image recognition process uses a machine learning image recognition model that is trained using a plurality of training images.

7. The gardening appliance of claim 6, wherein the plurality of training images have varying image clarities, wherein the image clarities vary in at least one of image focus or image resolution.

8. The gardening appliance of claim 6, wherein the plurality of training images comprises images with at least one of obstructions, lighting levels below a predetermined threshold, camera angles not in view of the plant of interest, or tower blockage.

9. The gardening appliance of claim 1, wherein the controller is further configured to:
adjust at least one operating parameter of the gardening appliance while obtaining the series of images.

10. The gardening appliance of claim 9, further comprising:
a lighting assembly for selectively illuminating the grow chamber, wherein adjusting the at least one operating parameter comprises operating the lighting assembly to vary lighting in the grow chamber while obtaining the series of images.

11. The gardening appliance of claim 1, wherein controller is in operative communication with a remote server through an external network and wherein the analysis of the series of images using the machine learning image recognition process is performed on the remote server.

12. The gardening appliance of claim 1, wherein the analysis of the series of images using the machine learning image recognition process is performed on the controller.

13. The gardening appliance of claim 1, wherein the machine learning image recognition process comprises at least one of a convolution neural network (“CNN”), a region-based convolution neural network (“R-CNN”), a deep belief network (“DBN”), a deep neural network (“DNN”), or a vision transformer (“ViT”) image recognition process.

14. The gardening appliance of claim 1, wherein the camera assembly consists of a single camera mounted in a corner of the cabinet.

15. The gardening appliance of claim 14, wherein the single camera comprises a wide-angle curvilinear lens.

16. A method of operating a camera assembly in a gardening appliance, the gardening appliance comprising a grow tower rotatably mounted within a liner and having a plurality of apertures for receiving one or more plant pods, and a motor assembly operably coupled to the grow tower for selectively rotating the grow tower, the method comprising:
operating the motor assembly to rotate the grow tower;
identifying a plant of interest;
determining a target tower position based on the plant of interest;
obtaining a series of images as the grow tower is rotated past the target tower position; and
analyzing the series of images using a machine learning image recognition process to identify a target image of the series of images.

17. (canceled)

18. (canceled)

19. The method of claim 16, wherein the machine learning image recognition process uses a machine learning image recognition model that is trained using a plurality of training images have varying plant and image clarities, along with at least one of obstructions, lighting issues, poor camera angles, or tower blockage.

20. The method of claim 16, wherein the machine learning image recognition process comprises at least one of a convolution neural network (“CNN”), a region-based convolution neural network (“R-CNN”), a deep belief network (“DBN”), a deep neural network (“DNN”), or a vision transformer (“ViT”) image recognition process.
